(19) United States
(12) Patent Application Publication
(10) Pub. No.: US 2010/0199499 A1
(43) Pub. Date: Aug. 12, 2010

(54) TUBING CUTTER

(75) Inventor: Oscar J. Dibble, Gordonsville, VA (US)

Correspondence Address: RANKIN, HILL & CLARK LLP, 38210 GLENN AVENUE, WILLOUGHBY, OH, 44094-7808, US

(73) Assignee: EMERSON ELECTRIC CO., St. Louis, MO (US)

(21) Appl. No.: 12/367,509

(22) Filed: Feb. 7, 2009

(51) Int. Cl. B23D 21/08

(52) U.S. Cl. 30/102

(57) ABSTRACT

A tube cutter is disclosed having a frame roller assembly and a cutting wheel assembly. The frame roller assembly includes two or more independently rotatable frame rollers which share a common axis. The cutting wheel assembly includes a cutter wheel disposed between two independently rotatable slide rollers, the cutter wheel and slide rollers sharing a common axis of rotation. The frame rollers are generally aligned with the slide rollers during a cutting operation. The tube cutter retains the ends of a tube during and after cut completion. The tube cutter is particularly suited for cutting corrugated tubing, and most particularly, a range of different sizes and configurations of corrugated tubing.

### FIELD OF THE INVENTION

The present invention relates to a tubing cutter, and particularly a tubing cutter for cutting corrugated tubing.

### BACKGROUND OF THE INVENTION

A wide array of devices are known for cutting or otherwise severing pipes and tubes. For many applications, a manual tubing cutter can be used in which the operator clamps or otherwise urges a cutter wheel against the outer surface of the pipe or tube to be cut, and then rotates the cutter and wheel around the circumference of the pipe. As the cutter wheel severs the wall of the pipe, the cutter wheel is periodically or continually advanced radially inward until the wheel has cut through the wall of the pipe.

Although this strategy is used by a vast majority of pipe cutters of this type, difficulties can arise when attempting to cut corrugated pipe or tubing. Many of these difficulties are due to the configuration of the corrugation and inability of the cutter to hold the tubing as cutting nears completion, and particularly after cut completion. Most tubing cutters are designed for pipe having relatively smooth outer surfaces as opposed to alternating peaks and valleys associated with corrugated tubing. Thus, when the cutter wheel of such cutters breaks through the wall of the tube and particularly if corrugated, the engagement between the cutter and tube is typically lost and as a result, the cutter becomes loose and can become detached or otherwise separated from the tube or sections of tube if completely cut. Another consequence is that once severed, one or both sections of the cut tubing typically become dislodged from the cutting tool. This in turn can result in damage to the newly cut tube end.

Prior artisans have designed tubing cutters specifically for cutting corrugated tubing. An example of such a tool is described in U.S. Pat. No. 5,907,906 to Sweeney. Although satisfactory in many respects, it is believed that this device still suffers from the previously known problem of tubing portions becoming disengaged from the cutter after or near cut completion. Accordingly, a need remains for a cutting device that avoids or at least significantly reduces the tendency for such occurrence, and particularly for such a cutting device which is adapted for cutting corrugated wall tubing or pipes.

Another difficulty associated with known tubing cutters when used for cutting corrugated tubing of different diameters, is that the configuration and spacing of the corrugations differs significantly between different size tubing. For example, certain 1 inch corrugated tubing typically features ridges having a spacing of about 0.224 inches from peak to adjacent peak, while other ⅜ inch corrugated tubing typically exhibits a peak-to-peak spacing of about 0.158 inches. Significant differences also exist in the respective radii of convex curvature of ridges and concave curvature of valleys in different size corrugated tubing. For example, 1 inch corrugated tubing may exhibit a ridge tip having a curvature defined by a radius of 0.070 inches and a valley recess curvature defined by a radius of 0.035 inches. In contrast, ⅜ inch corrugated tubing typically exhibits ridge tip and valley recess curvatures that have the same radius, such as 0.030 inches. Furthermore, the configurations of the corrugation of the different size tubing may be different. Many 1 inch corrugated tubes exhibit a symmetrical pattern of ridges, i.e. each ridge having a symmetrical shape about its peak. In contrast, certain ⅜ inch tubing may exhibit a non-symmetrical configuration.

These differences in geometry between different size corrugated tubing present difficulties in designing a single cutting tool that can be used for a range of different size tubing. Previously known tube cutters, suitable for cutting one size of corrugated tubing, e.g. 1 inch, are typically unsuitable for cutting corrugated tubing of a different size, e.g. ⅜ inch. As will be appreciated, this requires a worker to obtain and typically carry with him or her, multiple tube cutters. Therefore, a need exists for a tube cutter that can be used to cut a range of different size corrugated tubes.

### SUMMARY OF THE INVENTION

The difficulties and drawbacks associated with previous-type systems are overcome in the present apparatus for a tubing cutter which is particularly suited for cutting corrugated tubing.

In one aspect, the present invention provides a tube cutter for cutting a circular tube having a tube axis. The cutter comprises a housing having a cradle, a base, and a frame member generally extending between the cradle and the base. The cutter also comprises a selectively linearly positionable assembly engaged to the housing, the positionable assembly defining a first end and a second end opposite the first end. The cutter further comprises a frame roller assembly rotatably supported by the cradle, the frame roller assembly having an axis of rotation parallel to the tube axis. And, the cutter comprises a cutting wheel assembly engaged to the first end of the positionable assembly. The cutter wheel assembly is movable by linearly positioning the positionable assembly. The cutting wheel assembly comprises a cutter wheel and at least one independently rotatable slide roller proximate the cutter wheel. The cutter wheel and the at least one slide roller also share a common axis of rotation which is parallel to the tube axis.

In another aspect, the present invention provides a tube cutter for cutting a circular tube having a tube axis. The cutter comprises a housing having a cradle, a base, and a frame member generally extending between the cradle and the base. The tube cutter also comprises a selectively linearly positionable assembly engaged to the housing, the positionable assembly defining a first end and a second end opposite the first end. The tube cutter further comprises a cutting wheel assembly engaged to the first end of the positionable assembly. The cutter wheel assembly is movable by linearly positioning the assembly. The cutting wheel assembly includes a cutter wheel and at least one independently rotatable slide roller proximate the cutter wheel. The tube cutter also comprises a frame roller assembly rotatably supported by the cradle. The frame roller assembly has an axis of rotation parallel to the tube axis. The frame roller assembly comprises two or more independently rotatable frame rollers.

In yet another aspect, the present invention provides a tube cutter adapted for cutting a circular tube. The tube cutter comprises a housing having a first end and a second end. The tube cutter also comprises a linearly positionable cutting wheel assembly engaged at the first end of the housing. The cutting wheel assembly includes a first slide roller, a cutter wheel, and a second slide roller. Each of the first and second slide rollers and the cutter wheel is independently rotatable along a common axis of rotation. The cutter wheel is disposed between the first and second slide rollers. The tube cutter also comprises a frame roller assembly engaged at the second end of the housing. The frame roller assembly includes a first frame roller and a second frame roller. Each of the first and second frame rollers being independently rotatable along a common axis of rotation. The first slide roller is aligned with the first frame roller and the second slide roller is aligned with the second frame roller

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a perspective view of a preferred embodiment cutting tool of the present invention being used to cut a corrugated workpiece.

FIG. 2 is a detailed perspective view of the cutting head of the preferred embodiment cutting tool shown in FIG. 1.

FIG. 3 is an exploded view of the preferred embodiment cutting tool in accordance with the present invention.

FIG. 4 is a detailed view of a portion of the housing of the tool depicted in FIG. 3 illustrating an optional embodiment.

FIG. 5 is a schematic view of a typical corrugated workpiece.

FIG. 6 is a front elevational view of portion of a corrugated workpiece undergoing a cutting operation by the preferred embodiment cutting tool in accordance with the present invention.

FIG. 7 is a schematic cross sectional view of a preferred frame roller used in the preferred embodiment cutting tool.

FIG. 8 is a schematic cross sectional view of a preferred slide roller used in the preferred embodiment cutting tool.

FIG. 9 is a front view of a preferred slide mount used in the preferred embodiment cutting tool.

FIG. 10 is a side view of the slide mount illustrated in FIG. 9.

FIG. 11 is a partial frontal view of the preferred embodiment cutting tool illustrating the slide mount with a cutter wheel and two slide rollers.

FIG. 12 is a partial frontal view of the preferred embodiment cutting tool illustrating the slide mount assembly and an opposing assembly of frame rollers during a typical cutting operation of a corrugated workpiece.

FIG. 13 is a perspective view of another preferred embodiment cutting tool in accordance with the present invention.

FIG. 14 is a front view of the preferred embodiment tool illustrated in FIG. 13 showing a cutting head and roller assemblies in greater detail.

### DETAILED DESCRIPTION OF THE PREFERRED EMBODIMENTS

Generally, the present invention relates to a tubing cutter designed to remedy the problems associated with currently known tubing cutters when the cutter wheel breaks through thin wall tubing. Frequently, tubing will break free from the cutter and often become deformed.

The present invention tubing cutter provides a tubing cutter comprising a set of guide wheels, one on each side of a cutter wheel, and a corresponding set of frame rollers on a frame member opposite the guide wheels and cutter wheel. Each of these wheels and rollers is preferably independently rotatable. As the tubing cutter severs a tube wall, rollers and/or guide wheels on each side of the cutter wheel serve to retain each severed end of the tube thereby preventing either or both ends of the tube from sudden displacement from the tool upon cut completion or near cut completion.

The present invention tubing cutter also utilizes particular frame roller assemblies and cutting wheel assemblies that enable a wide range of different size corrugated tubes to be cut using a single cutting tool in accordance with the invention. The frame roller assemblies preferably utilize two or more independently rotatable frame rollers which accommodate different sizes and configurations of tube corrugations. In certain versions, the frame roller assemblies also utilize axial spacing between the frame rollers, to further enable the frame rollers to accommodate varying corrugations. The preferred cutting wheel assembly uses two or more slide rollers or guide wheels that accommodate different sizes and configurations of tube corrugations. And, in certain versions, the cutting wheel assemblies also utilize axial spacing between the slide rollers and/or cutter wheel, to further enable the slide rollers to accommodate varying corrugations.

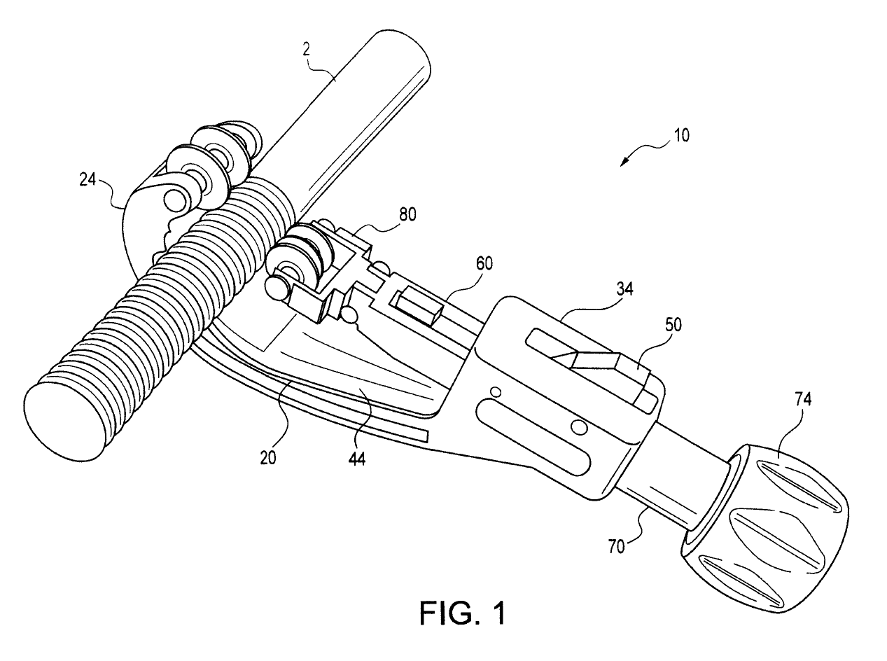

FIG. 1 is a perspective view of a preferred embodiment cutting tool 10 being used to cut or otherwise sever a pipe or workpiece 2, and particularly within a corrugated region of the workpiece. The tube cutter 10 comprises a housing 20 having a first end and a second end, preferably in the form of a cradle 24 and a base 34. A frame member 44 extends between the cradle 24 and the base 34 and is preferably formed integral therewith. A feed screw assembly 70 is engaged with the base 34 and serves to displace a yoke 80 toward the workpiece 2 to be cut. A slide 60 extends between the yoke 80 and the feed screw 70. Preferably, the feed screw assembly 70 includes a handle 74 which upon rotation, moves the yoke 80 closer to, or further from, the workpiece 2. The tube cutter 10 also comprises a latch 50 for selectively releasing the feed screw assembly 70 from the base 34 to thereby allow the slide 60 to freely move within the base 34.

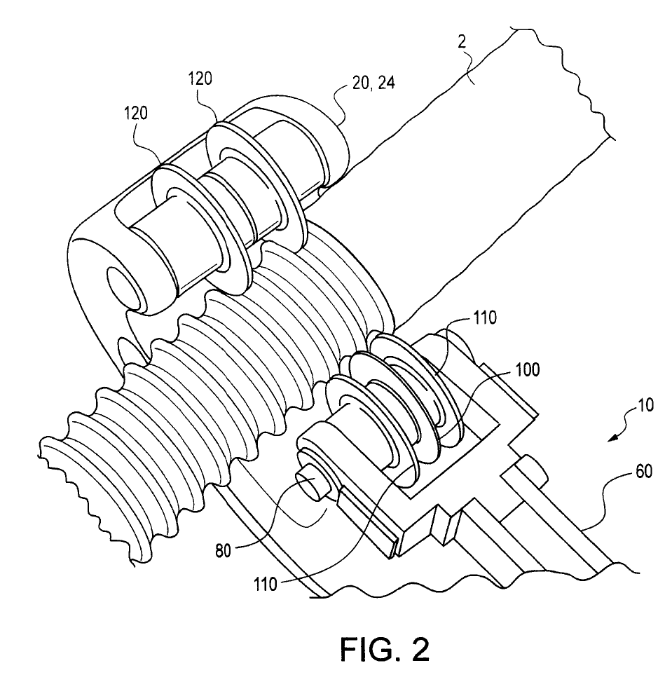

FIG. 2 is a detailed perspective view of the head portion of the housing 20 of the preferred embodiment tube cutter 10. The housing 20 includes the cradle 24 which as explained in greater detail herein rotatably supports a plurality of frame rollers 120. The yoke 80 rotatably supports a plurality of slide rollers 110 and a cutter wheel 100, as are also explained in greater detail herein. Although not shown in FIG. 2, the tube cutter 10 also preferably comprises a second assembly of frame rollers 120 such as positioned behind the workpiece 2 and thus, not visible in FIG. 2.

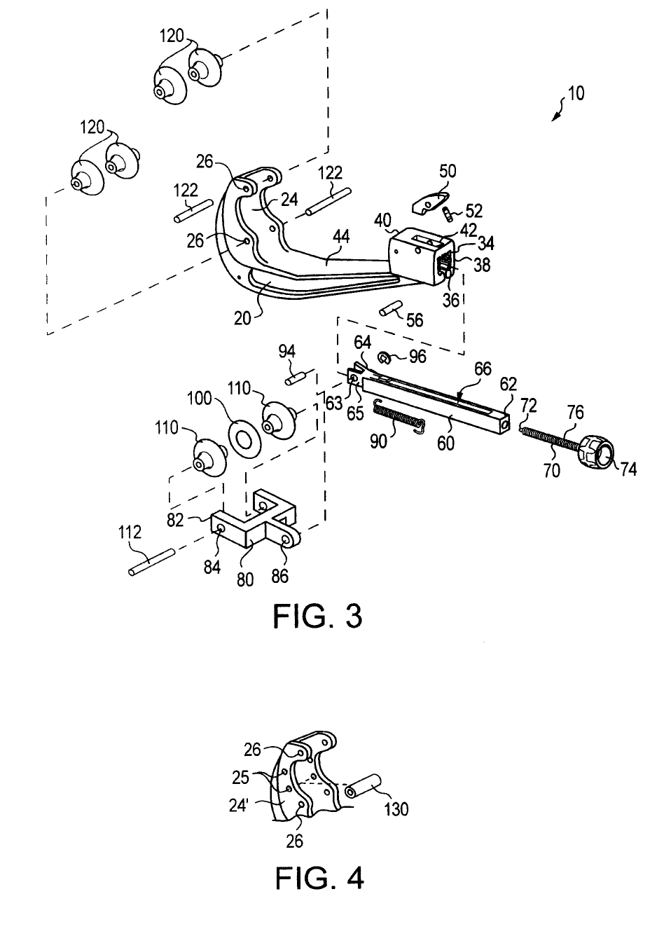

FIG. 3 is a schematic exploded view of the preferred embodiment tube cutter 10 illustrating many of its major components and assembly. The tube cutter 10 comprises the housing 20, in which the slide 60 is linearly positionable within the base 34 of the housing 20. The yoke 80 is releasably attached to one end of the slide 60, and the feed screw assembly 70 is preferably engaged or otherwise coupled to the opposite end of the slide 60. Specifically, the housing 20, as previously noted, includes the cradle 24, the base 34, and one or more frame members 44 extending therebetween. Defined along the cradle 24 are a plurality of roller apertures 26 extending through the members constituting the cradle 24. The roller apertures 26 receive and rotatably support one or more axles 122 which in turn rotatably support the frame rollers 120. As previously noted, preferably the tube cutter 10 comprises a first set of frame rollers 120 and corresponding axle 122 rotatably retained within the cradle 24, and also a second set of frame rollers 120 and corresponding axle 122 also rotatably retained within the cradle 24. The present invention contemplates the use of additional sets of frame rollers such as a third and potentially a fourth set of frame rollers 120 (not shown). The base 34 defines a first face 38 and an oppositely directed second face 40. An interior chamber 36 is defined within the base 34 and preferably accessible from both the first and second faces 38 and 40. The chamber 36 is configured to receive the slide 60. Preferably defined on a region of the base 34 extending between the first and second faces 38 and 40, is a slot 42. The slot 42 preferably provides access to the chamber 36 and is sized and configured to receive the latch 50 which is rotatably secured within the base 34 by a latch pin 56. A spring 52 or other biasing member may be used to urge the latch 50 in a desired position relative to the base 34 and/or slide 60 disposed within the chamber 36.

With further reference to FIG. 3, the slide 60 defines a first end 62 at which the feed screw assembly 70 is preferably engaged or otherwise attached. The slide 60 also defines a second end 64 opposite from the first end 62 at which is provided an engagement member 65. The engagement member 65 defines an aperture 63 for receiving a retaining pin 94 used for attaching the yoke 80 to the slide 60. As will be appreciated, pin 94 extends through an aperture 86 defined in the yoke 80. A retaining member 96 can be used to secure the end of the pin 94 and yoke 80 upon assembly. The feed screw assembly utilizes a threaded member 76 having the handle 74 at one end and a seat end 72 at its other end. The member 76 is threadedly engaged with the interior of the base 34 such that upon rotation of the handle 74 and thus member 76, the member 76 is linearly displaced relative to the base 34. The seat end 72 contacts or otherwise engages the end 62 of the slide 60 and thus also linearly displaces the slide 60. A biasing member or spring 90 may be used to urge the slide to a desired position.

It will be appreciated that the present invention is not limited to the particular assembly of slide 60, feed screw 70, and base 34 for selectively positioning the yoke 80 carrying the cutter wheel 100. That is, instead of this assembly, other assemblies as known in the art can be utilized in the preferred embodiment tube cutters so long as the cutter wheel can be radially positioned with respect to a tube to be cut, and particularly, positioned closer to, or further from, the longitudinal axis of the tube. The present invention tubing cutters may utilize other features and assemblies of known tubing cutters such as described in U.S. Pat. No. 6,393,700 to Babb.

Referring further to FIG. 3, the yoke 80 preferably includes two outwardly projecting and spaced members 82 for supporting an axle 112. The axle 112 extends through the support members 82 and particularly through apertures 84 defined in the members 82. The axle 112 rotatably supports one or more slide rollers 110 and the cutter wheel 100.

As previously noted, the preferred embodiment tube cutter 10 includes at least one, and preferably two or more frame roller assemblies. FIG. 3 illustrates two sets of frame rollers 120, each set rotatably supported on an axle 122 retained within the cradle 24 of the housing 20.

FIG. 4 illustrates an optional version of the tubing cutter embodiment 10 illustrated in FIGS. 1-3. In this alternate embodiment, the cradle 24′ defines one or more apertures 25 for engagement with an optional roller pin 130. As will be appreciated by those skilled in the art, certain tubing cutters may utilize roller pins 130 for providing additional support against a workpiece or pipe to be cut.

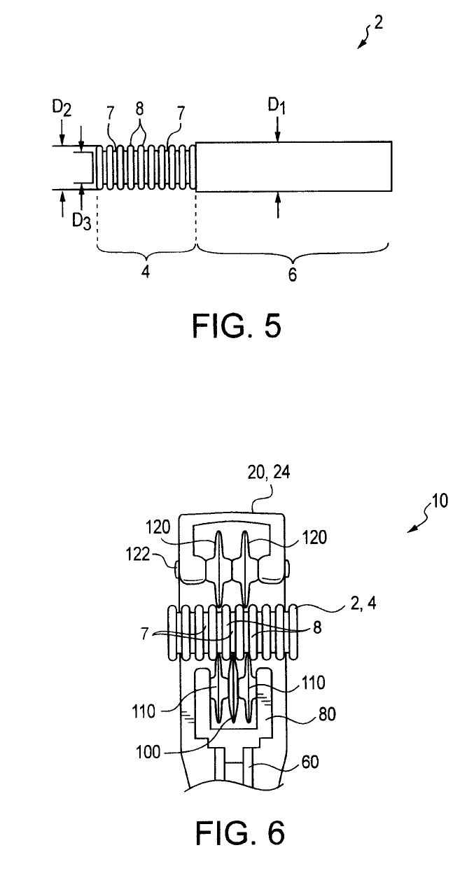

FIG. 5 is a schematic view of a portion of a pipe or workpiece 2 to which the preferred embodiment tube cutter 10 is adapted for cutting. The workpiece 2 includes a corrugated inner portion 4 and an outer sheath 6 generally surrounding and enclosing the inner portion 4. The corrugated inner portion 4 includes a plurality of outwardly projecting ridges 8 each separated by an inwardly recessed valley 7. The outer sheath 6 can be characterized as having an outer diameter D1. The corrugated inner portion 4 can be characterized as having an outer diameter D2 and an inner diameter D3.

When referring to different sizes of corrugated tubing, typically a diameter is referenced. However, it will be understood that the particular corrugated tubing corresponding to that diameter exhibits a certain inside diameter, outside diameter, and if jacketed, an outside diameter of the jacket, which are all typically larger than the referenced diameter. For example, a specially corrugated jacketed tubing such as Tracpipe® available from Omegaflex, Inc. of Exton, Pa., exhibits these various dimensions as shown in Table 1 below:

TABLE 1
Various Dimensions of Certain Specialty
Corrugated and Jacketed Tubing

| | Size (inch) | | | | | | |
|---|---|---|---|---|---|---|---|
| | ⅜″ | ½″ | ¾″ | 1″ | 1¼″ | 1½″ | 2″ |
| Jacket O.D. (max.), | .668 | .868 | 1.108 | 1.38 | 1.665 | 1.920 | 2.590 |
| D1 | | | | | | | |
| Inside Dia. (nom), D3 | .440 | .597 | .820 | 1.040 | 1.290 | 1.525 | 2.060 |

Thus, the various diameters associated with corrugated tubing, particularly if jacketed, are typically significantly larger than the referenced diameter. Therefore, the preferred embodiment tube cutters of the present invention are configured to accommodate the actual and relatively large diameters of corrugated tubing. It will be understood that when cutting or severing jacketed tubing, the portion of the jacket in the cut region is typically removed by the operator prior to tube cutting. However, the outside diameter D₂ and the inside diameter D₃ of the corrugated tubing are still typically larger than the referenced diameter.

It will be appreciated that the present invention tubing cutters are adapted for cutting a wide array of different types of tubing including, but not limited to jacketed tubing, non-jacketed tubing, corrugated, non-corrugated, and various specialty tubing in addition to the noted Tracpipe®.

FIG. 6 is a front elevational view showing in detail the slide rollers 110 rotatably mounted in the yoke 80, and at least one set of frame rollers 120 rotatably supported within the cradle 24 of the housing 20 of the preferred embodiment tube cutter 10. The tube cutter 10 is shown in use during a cutting operation of a workpiece 2 and particularly, a corrugated inner portion 4. During such cutting operation, the cutter wheel 100 is positioned within a valley 7 defined between adjacent ridges 8 of the corrugated workpiece. Each slide roller 110 disposed on opposite sides of the cutter wheel 100 is correspondingly positioned within an adjacent valley 7. It will be noted that the frame rollers 120 disposed along an opposite or generally opposite region of the workpiece 2 are each positioned in valleys 7 of the corrugated workpiece, and preferably within the same valley as are the slide rollers 110. In this preferred configuration, the frame rollers 120 and the slide rollers 110 are aligned with one another.

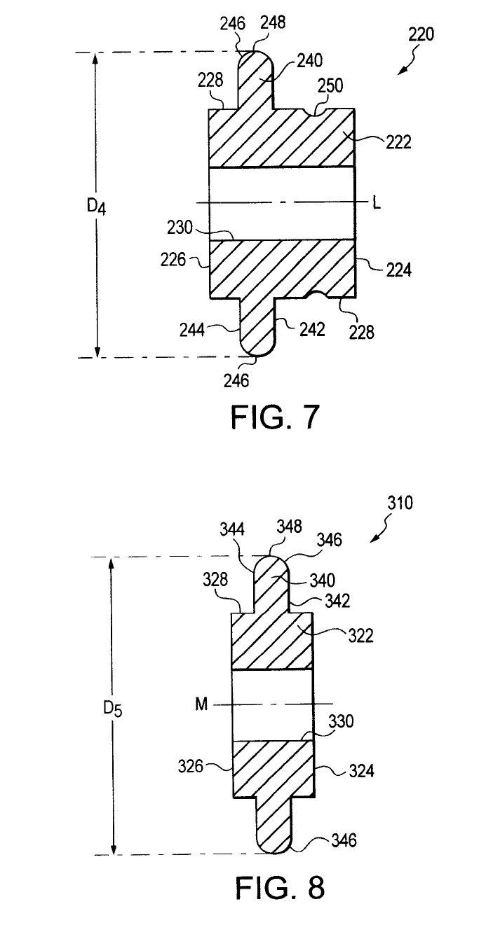

FIG. 7 is a schematic cross sectional view of a preferred embodiment frame roller 220 which comprises a body portion 222 defining a first end 224, an oppositely directed second end 226, and a generally cylindrical outer wall 228 extending therebetween. An interior hollow region is defined within the roller 220, by an interior circumferential wall 230. The hollow region preferably extends between the ends 224 and 226 and is sized and configured to receive an axle, such as axle 122 shown in FIG. 3.

The preferred frame roller 220 includes an outwardly extending and preferably radially extending member 240, preferably extending completely around the circumference of the outer wall 228. Preferably, the member 240 is integrally formed with the body portion 222 of the roller 220. The outwardly extending member 240 defines first and second faces 242 and 244, respectively, and a curved or convex outer surface 246 extending between the faces 242 and 244. A peak or rather ridge line 248 is defined at a location on the outer surface 246 having the greatest radial distance from the center axis L of the roller 220. An optional identification groove 250 is defined along the outer circumferential wall 228. The groove 250 is preferably defined between the member 240 and one of the ends, such as end 224. The optional groove 250 may promote identification between frame rollers of different size and/or configuration.

FIG. 8 is a schematic cross sectional view of a preferred embodiment slide roller 310 comprising a body portion 322 defining a first end 324, an oppositely directed second end 326, and a generally cylindrical outer wall 328 extending therebetween. An interior hollow region is defined within the roller 310, by an interior circumferential wall 330. The hollow region preferably extends between the ends 324 and 326 and is sized and configured to receive an axle, such as axle 112 shown in FIG. 3.

The preferred slide roller 310 includes an outwardly extending member 340, preferably extending completely around the circumference of the outer wall 328. Preferably, the member 340 is integrally formed with the body portion 322 of the roller 310. The outwardly extending member 340 defines first and second faces 342 and 344, respectively, and a curved or convex outer surface 346 extending between the faces 342 and 344. A peak or rather ridge line 348 is defined at a location on the outer surface 346 having the greatest radial distance from the center axis M of the roller 310.

The height of the member 240 as measured from the surface 228, the width of the member 240, and the width of the frame roller 220 are selected such that upon incorporation in a frame roller assembly as described herein, the member 240 can be positioned within a valley 7 without interference or contact along undesired locations by adjacent ridges 8. Similarly, the height of the member 340 as measured from the surface 328, the width of the member 340, and the width of the slide roller 310 are selected such that upon incorporation in a cutting wheel assembly as described herein, the member 340 can be positioned within a valley 7 without interference or contact along undesired locations by adjacent ridges 8.

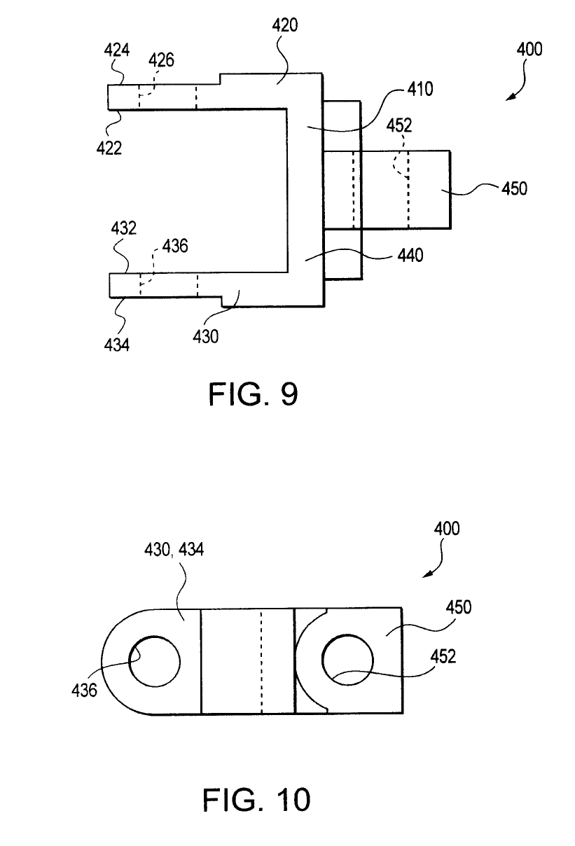

FIGS. 9 and 10 illustrate a preferred embodiment slide mount 400 in accordance with the present invention. The preferred slide mount 400 is used as, or in place of the yoke 80 illustrated in FIG. 3. FIG. 9 is a front view of the preferred embodiment slide mount 400 and FIG. 10 is a side view. The slide mount 400 serves to retain or otherwise provide for a rotatable support for one or more cutter wheels such as the cutter wheel 100 shown in FIG. 3 and one or more slide rollers such as slide rollers 110 in FIG. 3 or the slide rollers 310 in FIG. 8. Preferably, the slide mount 400 comprises a body portion 410 having two outwardly extending and preferably parallel support members 420 and 430. A connecting member 440 generally extends between the members 420 and 430. Each support member 420, 430 defines inner and outer faces. The member 420 defines an inner face 422 and an outer face 424. Similarly, the member 430 defines an inner face 432 and an oppositely directed outer face 434. Each member 420, 430 also defines an aperture 426, 436 sized and configured to receive an axle such as axle 112 shown in FIG. 3. The slide mount 400 also includes an engagement member 450 extending from the body portion 410 generally in a direction away from and parallel to the members 420, 430. The engagement member 450 defines an aperture 452 sized and configured to receive a retaining pin such as pin 94 shown in FIG. 3, to couple or otherwise attach the slide mount 400 to the slide 60, and specifically, to the member 65 disposed along an end of the slide 60.

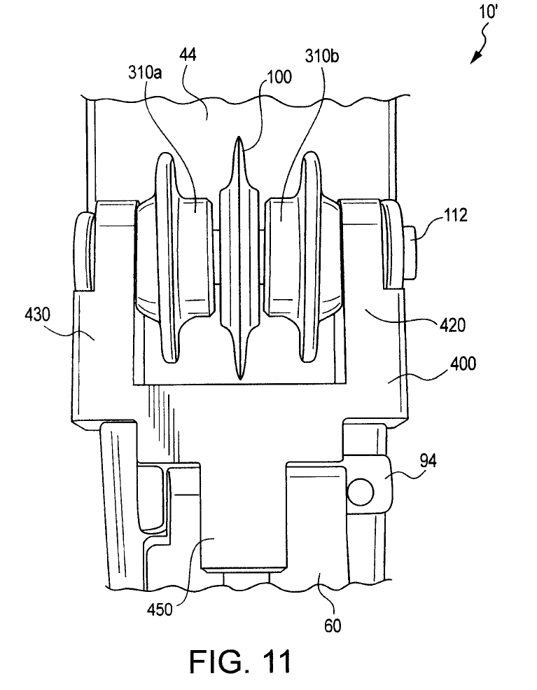

FIG. 11 is a partial frontal view of a preferred embodiment cutter 10′ utilizing the preferred slide mount 400 with a cutter wheel 100 and two preferred slide rollers 310a and 310b. Specifically, the slide mount 400 is engaged with and supported by the slide 60 via pin 94 extending through the aperture 63 (not shown) defined in the slide 60 and the aperture 452 (not shown) defined in the engagement member 450 of the slide mount 400. An axle 112 extends through apertures 426, 436 (not shown) defined in the members 420 and 430 of the slide mount 400. The axle 112 also extends through the apertures 330 (not shown) of the slide rollers 310a and 310b and through a corresponding aperture (not shown) in the cutter wheel 100.

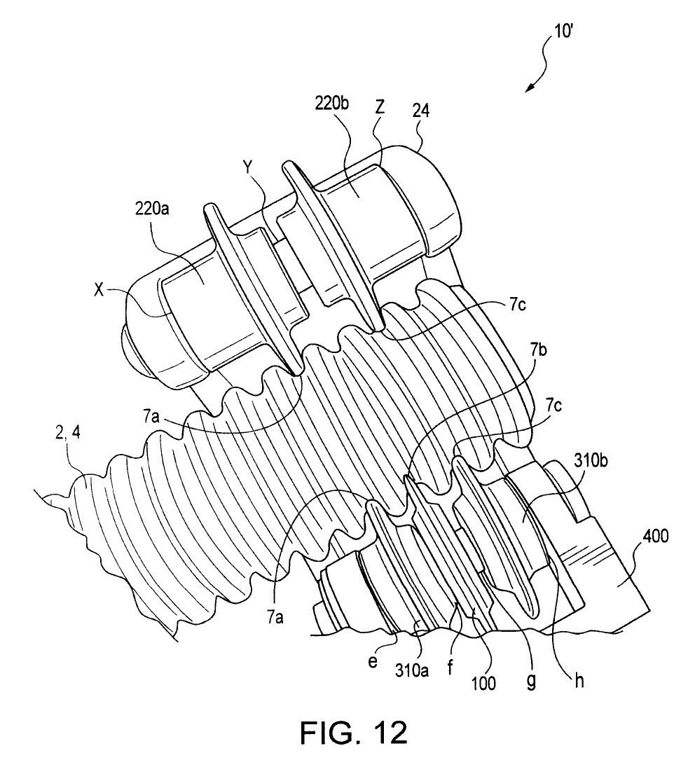

FIG. 12 is a partial frontal view of the preferred embodiment cutting tool 10′ illustrating the preferred slide mount 400 and related assembly as previously described with regard to FIG. 11, and an opposing assembly of frame rollers 220a and 220b during a typical cutting operation of a workpiece 2 and specifically, a corrugated region 4. Specifically, FIG. 12 illustrates the slide mount 400 rotatably supporting the cutter wheel 100 disposed between two slide rollers 310a and 310b. It can be seen that each of the cutter wheel and slide rollers are disposed in recessed portions and specifically, recessed valleys 7a, 7b, and 7c of the corrugated region 4. Most preferably, the assembly of slide mount 400 and cutter wheel 100 and slide rollers 310a and 310b is configured such that the slide rollers 310a, 310b are disposed in immediately adjacent valleys next to the valley in which the cutter wheel 100 is disposed. Thus, in FIG. 12, the cutter wheel 100 is disposed in valley 7b and the slide rollers 310a and 310b are disposed in immediately adjacent valleys 7a and 7c, respectively.

FIG. 12 also depicts an assembly of frame rollers 220a and 220b rotatably supported by a portion of the cradle 24. Preferably, one of the frame rollers 220a is disposed in the same valley as one of the slide rollers 310a, i.e. valley 7a. And, preferably the other frame roller 220b is disposed in the same valley as the other slide roller 310b, i.e. valley 7c. Thus, the frame roller 220a is aligned with the slide roller 310a, and the frame roller 220b is aligned with the slide roller 310b.

Another feature of the present invention is the discovery of particular ratios between the diameters of the cutter wheel and the slide rollers disposed alongside the cutter wheel in a preferred cutting wheel assembly. For a cutter wheel diameter of 0.750 inches, it has been discovered that the preferred diameter of the slide rollers, i.e. diameter D₅ shown in FIG. 8, is preferably within the range of from about 0.65 to about 0.70 inches, more preferably from about 0.66 to about 0.69 inches, and most preferably 0.67 inches. These diameter ratios can be conveniently expressed as percentages as follows. Thus, the diameter of the slide roller is preferably from about 86% to about 93%, more preferably from about 88% to about 92%, and most preferably about 89%, of the diameter of the cutter wheel. This feature is also depicted in FIG. 11 as it can be seen that the cutting wheel 100 diameter is greater than the diameters of the slide rollers 310a and 310b.

Although not wishing to be limited to any particular dimensions for the slide roller 310 depicted in FIG. 8, for such a roller 310 having a diameter D₅, the preferred proportions of other aspects of the roller are as follows. The preferred height of the member 340 as measured by the radial distance between the ridge 348 and the outer circumferential surface 328 is about 0.15 inches. The preferred width of the member 340 as measured by the distance between the faces 342 and 344 is about 0.05 inches. Preferably, the radius of the convex surface 346 along the tip of the member 340 is about 0.025 inches. The preferred width of the roller 310 as measured by the distance between the ends 324 and 326 is from about 0.17 inches to about 0.23 inches. And, the preferred interior span or diameter of the passage defined by the wall 330 is about 0.189 inches.

The frame roller such as the frame roller 220 depicted in FIG. 7 also has various preferred proportions and dimensions. For example, the preferred diameter for the frame roller 220 designated as diameter D₄ in FIG. 7, is preferably about 0.75 inches. The thickness of the roller 220 as measured by the distance between the ends 224 and 226 is about 0.400 inches. The diameter or span of the interior passage defined by the wall 230 is about 0.189 inches. The thickness of the member 240 as measured by the distance between its faces 242 and 244 is about 0.06 inches. And, the radius of curvature of the convex surface defined along the distal end extending between the faces 242 and 244 is about 0.030 inches. The height of the member 240 as measured by the radial distance between the ridge 248 and the outer surface 228 is about 0.20 inches. In certain embodiments, it is preferred to locate the member 240 such that it is closer to one of the ends 224, 226 than the other. In the embodiment shown in FIG. 7, the member 240 is disposed closer to the end 226 than the other end 224, and most preferably, positioned a distance from the end 224 whereby the distance between the face 242 of the member 240 and the end 224 is about 0.255 inches.

The various proportions and dimensions for the preferred frame rollers and slide rollers have been discovered to result in frame roller assemblies and cutting wheel assemblies which perform efficiently and effectively. When utilized for cutting corrugated tubing, frame rollers and slide rollers having such proportions and dimensions, readily engage the tubing with little or no interference with other regions of the frame rollers, slide roller, and/or associated regions of the tube cutters.

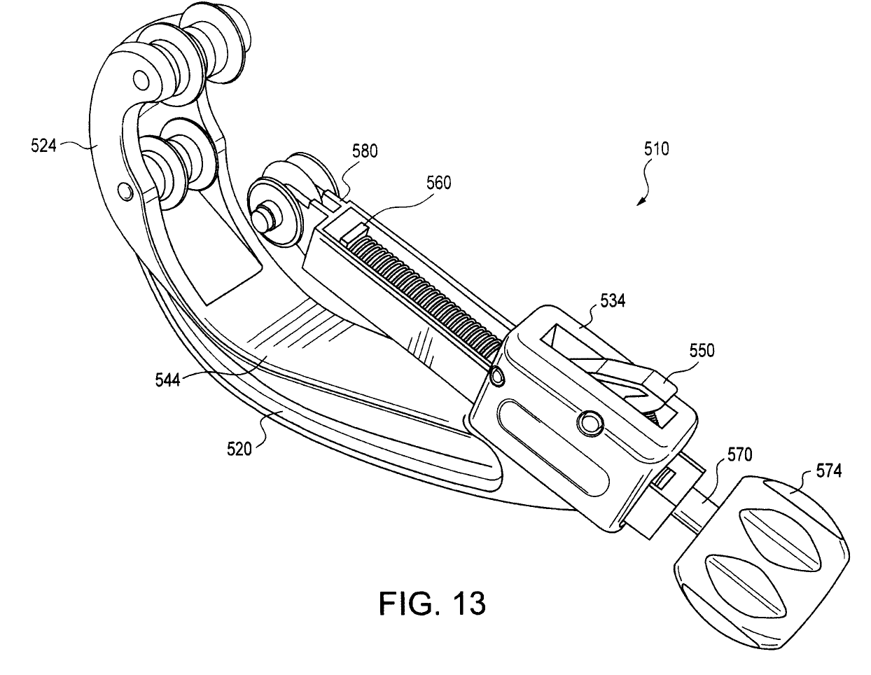

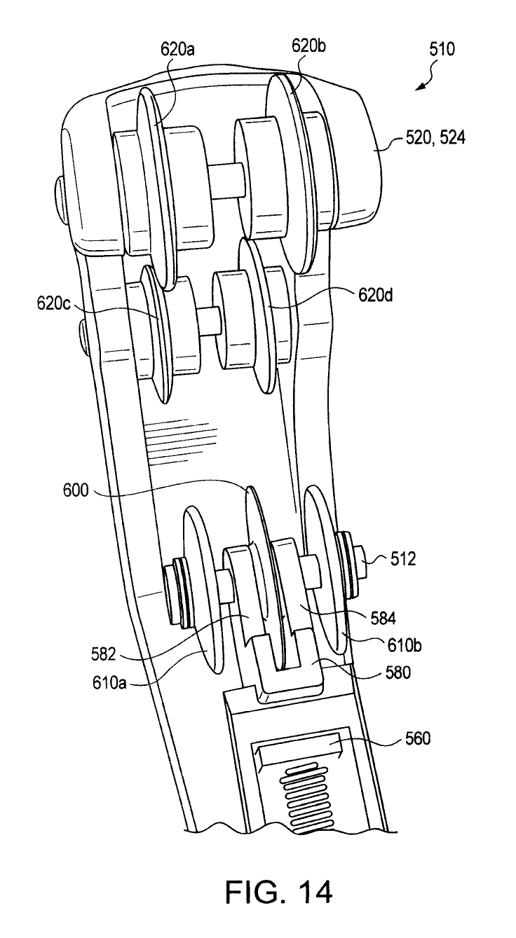

In a preferred aspect, the wheels and rollers are configured, i.e. shaped and sized, to accommodate corrugations in certain specialty tubing, such as in Tracpipe®, and for the preferred embodiment tube cutters to be used with a range of different size specialty tubing. A specific range for corrugated tubing is contemplated, such as ⅜ inch to 1 inch tubing. It is also contemplated that a preferred embodiment tube cutter be provided that accommodates different size corrugated tubing, such as from ¾ inch to 2 inch tubing. Another preferred range of tubing sizes to be accommodated by a cutting tool as described herein is from 1¼ inch to 2 inches. FIGS. 13 and 14, described herein, illustrate such a tool.

FIG. 13 is a perspective view of another preferred embodiment cutting tool 510 in accordance with the present invention. The cutting tool 510 is preferably sized to accommodate cutting corrugated tubing from 1¼ inches to 2 inches. The tube cutter 510 comprises a housing 520 having a first end and a second end, preferably in the form of a cradle 524 and a base 534. A frame member 544 extends between the cradle 524 and the base 534 and is preferably formed integral therewith. A feed screw assembly 570 is engaged with the base 534 and serves to displace a slide mount 580 toward a workpiece (not shown) to be cut. A slide 560 extends between the slide mount 580 and the feed screw 570. Preferably, the feed screw assembly 570 includes a handle 574 which upon rotation, moves the slide mount 580 closer to, or further from, the workpiece. The tube cutter 510 also comprises a latch 550 for selectively releasing the feed screw assembly 570 from the base 534 to thereby allow the slide 560 to freely move within the base 534.

FIG. 14 is a detailed frontal view of the head portion of the housing 520 of the preferred embodiment tube cutter 510. The housing 520 includes the cradle 524 which as explained in greater detail herein rotatably supports a plurality of frame rollers 620a and 620b. The slide mount 580 rotatably supports a plurality of slide rollers 610a and 610b and a cutter wheel 600, as are also explained in greater detail herein.

FIG. 14 illustrates the preferred embodiment cutter 510 utilizing the preferred slide mount 580 with a cutter wheel 600 and two preferred slide rollers 610a and 610b. Specifically, the slide mount 580 is engaged with and supported by the slide 560. The slide mount 580 includes two upwardly extending members 582 and 584. An axle 512 extends through apertures (not shown) defined in the members 582 and 584 of the slide mount 580. The axle 512 also extends through apertures (not shown) of the slide rollers 610a and 610b and through a corresponding aperture (not shown) in the cutter wheel 600. A difference between the slide mount 580 of the preferred embodiment tool 510 and the slide mount 400 of the tool 10′, relates to the configuration of the support members 582 and 584. In the tool 510, the members 582 and 584 are each disposed between the cutting wheel 600 and a corresponding slide roller 610a or 610b. As will be noted from a review of FIG. 11, the slide mount 400 of the tool 10′ utilizes members 430 and 420 that are positioned at lateral outer ends of the assembly of slide rollers 310a and 310b, and cutting wheel 100.

FIG. 14 also depicts an assembly of frame rollers 620c and 620d rotatably supported by a portion of the cradle 524. Preferably, the previously described frame roller 620a is aligned with the slide roller 610a, and the frame roller 620b is aligned with the slide roller 610b. And, the frame roller 620c is aligned with the frame roller 620a and the slide roller 610a. And, the frame roller 620d is aligned with the frame roller 620b and the slide roller 610b.

As previously noted, the preferred embodiment tubing cutters also exhibit an ability to not only cut corrugated tubing, but also a range of different sizes of corrugated tubing. This unique ability of the preferred embodiment tubing cutters is achieved by providing particular axial spacing between the cutter wheel and slide roller(s), and also between the frame rollers. Generally, in accordance with an aspect of the present invention, one or more of the cutting wheel assembly and the frame roller assembly(ies) have widths such that axial spacing is provided between each component in an assembly. The spacing is sufficient so that each component can move axially along its axle or support member a sufficient distance so that the component can be centered in its respective valley in the corrugated tubing to be cut. That is, during a cutting operation each of the components will center themselves in their respective valley. Generally, the amount of axial spacing can be expressed based upon each roller component, i.e. either a frame roller or a slide roller. And so, the term “axial spacing” as used herein refers to the distance of spacing or freedom of axial movement, of a frame roller in a frame roller assembly or a slide roller in a cutting wheel assembly. Typically, for the cutting tools 10 and 10′, this axial spacing is from about 0.040 inches to about 0.150 inches, more preferably from about 0.050 to about 0.090 inches, and most preferably about 0.070 inches per roller component. Thus, for the frame roller assembly 220a and 220b depicted in FIG. 12, the total axial spacing allotted for regions x, y, and z is two times the noted axial spacing per component (since two frame rollers are used). Using a most preferred axial spacing of 0.070 inches, the most preferred total axial spacing allotted for regions x, y, and z is 0.14 inches. In the arrangement of frame rollers 220 shown in FIG. 12, it can be seen that the rollers 220a and 220b are positioned such that nearly all of the axial spacing of 0.14 inches is utilized in the region y, between the frame rollers 220a and 220b. With further reference to FIG. 12, for the cutting wheel assembly of slide roller 310a, cutter wheel 100, and slide roller 310b, the total axial spacing allotted for regions e, f, g, and h is from about 0.14 inches to about 0.04 inches, more preferably from about 0.12 inches to about 0.06 inches, and most preferably about 0.09 inches. That axial distance can be allotted in any manner between regions e-h, so long as the total axial distance of each of those regions sums to the noted value or range of dimensions, i.e. a most preferred axial distance of 0.09 inches.

The cutting tool 510 exhibits several preferred features as follows. Axial spacing, as that term is used herein, is from about 0.130 to about 0.200 inches and preferably from about 0.150 to about 0.180 inches per roller component, i.e. for each of the slide rollers and the frame rollers. As with the previously described cutting tools 10 and 10′; the diameter of the cutting wheel 600 is larger than the diameter of the slide rollers 610a and 610b. Preferably, the diameter of the cutting wheel 600 is larger by an amount of from 0.100 inches to about 0.120 inches. For a cutting wheel having a diameter of 1.030 inches, the diameter of the slide roller is thus from about 0.91 to about 0.93 inches, which expressed as a percentage of the diameter of the cutter wheel, is from 88% to 90%. The diameter of the frame rollers, i.e. 620a, 620b, 620c, and 620d is from about 0.95 to about 1.20 inches, and preferably 1.030 inches.

The preferred embodiment tubing cutters of the present invention comprise one or more frame rollers and one or more slide rollers. Preferably, the frame rollers are arranged in sets, such as depicted in FIG. 3 where two sets of frame rollers 120 are illustrated. Each set of frame rollers may utilize from one to four or more frame rollers, however two frame rollers per set is preferred. The cutting wheel assemblies may also comprise from one to four or more slide rollers, all aligned along a common axis of rotation. Preferably, the cutting wheel assembly comprises two slide rollers and a cutter wheel.

In addition, although the particular frame rollers, slide rollers, and assemblies of such have been described with regard to a manual tubing cutter, the present invention includes powered tube cutters utilizing these components and/or assemblies.

Moreover, in all of the embodiments described herein, the cutting wheel and slide roller assembly is selectively displaced against the tube or workpiece to be cut while the one or more frame roller assemblies are stationary. The present invention includes cutters having a configuration in which a frame roller assembly is selectively displaced against a tube or workpiece while the axis of the cutting wheel assembly remains stationary.

Although the preferred embodiment tube cutters and their various features are described herein with reference to cutting corrugated tubes, it will be appreciated that the present invention is not limited to such applications or tubing.

Many other benefits will no doubt become apparent from future application and development of this technology.

All patents, published applications, and articles noted herein are hereby incorporated by reference in their entirety.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. A tube cutter for cutting a circular tube having a tube axis, the cutter comprising:
a housing having a cradle, a base, and a frame member generally extending between the cradle and the base;
a selectively linearly positionable assembly engaged to the housing, the positionable assembly defining a first end and a second end opposite the first end;
a frame roller assembly rotatably supported by the cradle, the frame roller assembly having an axis of rotation parallel to the tube axis;
a cutting wheel assembly engaged to the first end of the positionable assembly, the cutter wheel assembly being movable by linearly positioning the positionable assembly;
wherein the cutting wheel assembly comprises a cutter wheel and at least one independently rotatable slide roller proximate the cutter wheel, the cutter wheel and the at least one slide roller having a common axis of rotation which is parallel to the tube axis.

2. The tube cutter of claim 1 wherein the cutting wheel assembly comprises a first slide roller and a second slide roller, each of the first and the second slide rollers being independently rotatable about the common axis with the cutter wheel, the cutter wheel being disposed between the first and the second slide rollers.

3. The tube cutter of claim 1 wherein the frame roller assembly comprises two or more independently rotatable frame rollers.

4. The tube cutter of claim 1 where the frame roller assembly is a first frame roller assembly, the tube cutter further comprising:
a second frame roller assembly rotatably supported by the cradle, the second frame roller assembly having an axis of rotation parallel to the tube axis.

5. The tube cutter of claim 1 wherein the diameter of the cutter wheel is greater than the diameter of the slide roller.

6. The tube cutter of claim 5 wherein the diameter of the slide roller is from about 86% to about 93% of the diameter of the cutter wheel.

7. The tube cutter of claim 6 wherein the diameter of the slide roller is from about 88% to about 92% of the diameter of the cutter wheel.

8. The tube cutter of claim 7 wherein the diameter of the slide roller is about 89% of the diameter of the cutter wheel.

9. The tube cutter of claim 1 wherein the frame roller assembly comprises at least one frame roller, the frame roller having a diameter equal to the diameter of the cutter wheel.

10. The tube cutter of claim 1 wherein the frame roller assembly comprises a first frame roller and a second frame roller, the first and second frame rollers being independently rotatable, the cutting wheel assembly comprises a first slide roller and a second slide roller, the first and second slide rollers being independently rotatable, the first frame roller being aligned with the first slide roller and the second frame roller being aligned with the second slide roller.

11. The tube cutter of claim 1 wherein for each slide roller in the cutting wheel assembly, the cutting wheel assembly exhibits axial spacing of from about 0.040 inches to about 0.150 inches.

12. The tube cutter of claim 1 wherein for each slide roller in the cutting wheel assembly, the cutting wheel assembly exhibits axial spacing of from about 0.130 inches to about 0.200 inches.

13. The tube cutter of claim 3 wherein for each frame roller in the frame roller assembly, the frame roller assembly exhibits axial spacing of from about 0.040 inches to about 0.150 inches.

14. The tube cutter of claim 3 wherein for each frame roller in the frame roller assembly, the frame roller assembly exhibits axial spacing of from about 0.130 inches to about 0.200 inches.

15. A tube cutter for cutting a circular tube having a tube axis, the cutter comprising:
a housing having a cradle, a base, and a frame member generally extending between the cradle and the base;
a selectively linearly positionable assembly engaged to the housing, the positionable assembly defining a first end and a second end opposite the first end;
a cutting wheel assembly engaged to the first end of the positionable assembly, the cutter wheel assembly being movable by linearly positioning the assembly, the cutting wheel assembly including a cutter wheel and at least one independently rotatable slide roller proximate the cutter wheel;
a frame roller assembly rotatably supported by the cradle, the frame roller assembly having an axis of rotation parallel to the tube axis, the frame roller assembly comprising two or more independently rotatable frame rollers.

16. The tube cutter of claim 15 wherein the slide roller is aligned with one of the frame rollers.

17. The tube cutter of claim 15 wherein the slide roller is a first slide roller and the cutting wheel assembly further includes a second slide roller, the cutter wheel being disposed between the first and second slide rollers.

18. The tube cutter of claim 17 wherein the first slide roller is aligned with a first frame roller and the second slide roller is aligned with a second frame roller.

19. The tube cutter of claim 15 wherein the frame roller assembly is a first frame roller assembly, the tube cutter further comprising:
a second frame roller assembly rotatably supported by the cradle, the second frame roller assembly having an axis of rotation parallel to the tube axis.

20. The tube cutter of claim 15 wherein the cutter wheel and the at least one slide roller have a common axis of rotation which is parallel to the tube axis.

21. The tube cutter of claim 15 wherein the diameter of the cutter wheel is greater than the diameter of the slide roller.

22. The tube cutter of claim 21 wherein the diameter of the slide roller is from about 86% to about 93% of the diameter of the cutter wheel.

23. The tube cutter of claim 22 wherein the diameter of the slide roller is from about 88% to about 92% of the diameter of the cutter wheel.

24. The tube cutter of claim 23 wherein the diameter of the slide roller is about 89% of the diameter of the cutter wheel.

25. The tube cutter of claim 15 wherein for each slide roller in the cutting wheel assembly, the cutting wheel assembly exhibits axial spacing of from about 0.040 inches to about 0.150 inches.

26. The tube cutter of claim 15 wherein for each frame roller in the frame roller assembly, the frame roller assembly exhibits axial spacing of from about 0.040 inches to about 0.150 inches.

27. The tube cutter of claim 15 wherein for each slide roller in the cutting wheel assembly, the cutting wheel assembly exhibits axial spacing of from about 0.130 inches to about 0.200 inches.

28. The tube cutter of claim 15 wherein for each frame roller in the frame roller assembly, the frame roller assembly exhibits axial spacing of from about 0.130 inches to about 0.200 inches.

29. A tube cutter adapted for cutting a circular tube, the tube cutter comprising:
a housing having a first end and a second end;
a linearly positionable cutting wheel assembly engaged at the first end of the housing, the cutting wheel assembly including a first slide roller, a cutter wheel, and a second slide roller, each of the first and second slide rollers and the cutter wheel being independently rotatable along a common axis of rotation, the cutter wheel disposed between the first and second slide rollers;
a frame roller assembly engaged at the second end of the housing, the frame roller assembly including a first frame roller and a second frame roller, each of the first and second frame rollers being independently rotatable along a common axis of rotation;
wherein the first slide roller is aligned with the first frame roller and the second slide roller is aligned with the second frame roller.

30. The tube cutter of claim 29 wherein for each slide roller in the cutting wheel assembly, the cutting wheel assembly exhibits axial spacing of from about 0.040 inches to about 0.150 inches.

31. The tube cutter of claim 29 wherein for each frame roller in the frame roller assembly, the frame roller assembly exhibits axial spacing of from about 0.040 inches to about 0.150 inches.

32. The tube cutter of claim 29 wherein for each slide roller in the cutting wheel assembly, the cutting wheel assembly exhibits axial spacing of from about 0.130 inches to about 0.200 inches.

33. The tube cutter of claim 29 wherein for each frame roller in the frame roller assembly, the frame roller assembly exhibits axial spacing of from about 0.130 inches to about 0.200 inches.
